(19) United States
(12) Patent Application Publication
(10) Pub. No.: US 2005/0152671 A1
(43) Pub. Date: Jul. 14, 2005

(54) Apparatus and method for video signal recording/reproducing

(75) Inventor: Hideaki Shibata, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/023,589

(22) Filed: Dec. 29, 2004

(30) Foreign Application Priority Data
Jan. 9, 2004 (JP) 2004-004719

(51) Int. Cl. H04N 5/76; H04N 5/781

(52) U.S. Cl. 386/46; 386/125

(57) ABSTRACT

In a video signal recording/reproducing apparatus capable of outputting as a reproduced video signal a video signal which has been recorded in advance, a cuttable portion detection section detects a cutting portion in the received video signal while recording a received video signal. A cuttable portion identification section identifies whether or not a reproduced video signal reproduced from a storage device belongs to the cuttable portion detected by the cuttable portion detection section. A switch judgment section receives a result of detection by the cuttable portion detection section and a result of identification by the cuttable portion identification section, and gives an output switch section an instruction to switch a video signal to an output switching section when the switch judgment section judges that the reproduced video signal and the received video signal are contained in the same cuttable portion.

### BACKGROUND OF THE INVENTION

The present invention relates to a video signal recording/reproducing apparatus, and more particularly relates to a video signal recording/reproducing apparatus in which, while compressed stream data obtained by performing compression-coding to a received TV signal in a storage device is recorded, recorded compressed stream data is reproduced and the reproduced video signal is output, i.e., a video signal recording/reproducing apparatus which is capable of performing so-called time shift reproduction.

FIG. 4 is a block diagram illustrating the configuration of a known video signal recording/reproducing apparatus. In the known video signal recording/reproducing apparatus, a system controller 101 performs signal control, according to an operating instruction input by a viewer from an operation panel 108, by switching between a received video signal obtained by processing, by a tuner 103 and a demodulator 104, a TV signal received from an antenna 102 and a reproduced video signal obtained by compression-coding the received video signal by an MPEG1 encoder 105, recording the compression-coded signal in a hard disk drive 106, reproducing the recorded signal, and then decoding the reproduced signal by an MPEG1 decoder 107, thereby displaying the signal on a TV monitor 109. Furthermore, as for signal reproduction, according to a viewer's operation from the operation panel 108, the system controller 101 issues an instruction to slowly reproduce part of a program which the viewer wants to see in detail, or skip unnecessary part thereof, i.e., perform so-called skip reproduction (see, e.g., Japanese Laid-Open Publication No. 8-138318, page 4, FIG. 1).

In the video signal recording/reproducing apparatus, a certain amount of time is required to perform compression-coding of a received video signal, recording of a signal on a hard disk drive, reproduction from the hard disk drive and decoding of compression-coded data. Therefore, even if fast-forward reproduction or skip reproduction is performed, a reproduced video signal never completely catches up with a received video signal being received. For this reason, even when a reproduced video signal has reached very close to a received video signal by fast-forwarding reproduction or skip reproduction, a viewer views a reproduced video image until the end of the video image program unless the viewer switches the reproduced video image. Particularly, in analog broadcasting, the quality of a compression-coded reproduced video signal is deteriorated to a further extent than that of a received video signal in terms of both of image and sound qualities. Thus, the viewer continues to see a reproduced video image with deteriorated quality.

### SUMMARY OF THE INVENTION

In view of above-described problems, it is therefore an object of the present invention to provide video signal recording/reproducing apparatus and method which allow, when a reproduced video signal comes to very close to a received video signal by fast-forwarding reproduction and skip reproduction, an output is switched from the reproduced video signal to the received video signal automatically or semiautomatically.

Means which has been devised to solve the above-described problems, as a video signal recording/reproducing apparatus which selectively outputs one of the received video signal and a reproduced video signal obtained by reproducing a recorded received video signal while recording a received video signal, includes a switch judgment section for examining whether or not each of the received video signal and the reproduced video signal satisfies a predetermined condition while the reproduced video signal is output and making a judgment of switching an output to the received video signal if the predetermined condition is satisfied.

Moreover, as a semiconductor integrated circuit to which a received video signal is input and which selectively outputs, while recording the received video signal in a storage device, one of the received video signal and a reproduced video signal obtained by decoding data read out from the storage device, means which includes a switch judgment section for examining whether or not each of the received video signal and the reproduced video signal satisfies a predetermined condition while the reproduced video signal is output and making a judgment of switching an output to the received video signal if the predetermined condition is satisfied is provided.

Then, as a method for recording/reproducing a video signal in which a received video signal is input and, while the received video signal is recorded in a storage device, one of the received video signal and a reproduced video signal obtained by decoding data read out from the storage device is selectively output, a method which includes the switch judgment step of examining whether or not each of the received video signal and the reproduced video signal satisfies a predetermined condition while the reproduced video signal is output and making a judgment of switching an output to the received video signal if the predetermined condition is satisfied is provided.

According to the inventive apparatus, semiconductor integrated circuit and method, during outputting a reproduced video signal, when each of a received video signal and a reproduced video signal satisfies a predetermined condition, a judgment of switching an output to the received video signal is made by the switch judgment section or the switch judgment step. Then, based on the judgment, it becomes possible to automatically or semi-automatically switch an output.

It is preferable that the video signal recoding/reproducing apparatus includes: a time information generation section for generating time information to be superimposed on the received video signal; and a time information extraction section for extracting time information superimposed on the recorded received video signal. Then, the switch judgment section calculates a time difference between a time generated from the time information generation section and a time obtained from the time information extraction section, performs size comparison between the time difference and a predetermined value and, if the time difference is the predetermined value or less, makes a judgment of switching an output.

Moreover, it is preferable that the semiconductor integrated circuit includes: a time information generation section for generating time information to be superimposed on the received video signal; and a time information extraction section for extracting time information superimposed on data read out from the storage device. Then, the switch judgment section calculates a time difference between a time generated from the time information generation section and a time obtained from the time information extraction section, performs size comparison between the time difference and a predetermined value and, if the time difference is the predetermined value or less, makes a judgment of switching an output.

Moreover, it is preferable that the video signal recording/reproducing method includes: the time information generation step of generating time information to be superimposed on the received video signal: and the time information extraction step of extracting time information superimposed on data read out from the storage device. Then, in the switch judgment step, a time difference between a time generated by the time information generation step and a time extracted by the time information extraction section is calculated, size comparison between the time difference and a predetermined value is performed and, if the time difference is the predetermined level or less, a judgment of switching an output is made.

According to the above-described apparatus, semiconductor integrated circuit and method, during reproducing a reproduced video signal at high speed, when a time difference between the reproduced signal and a received video signal becomes a predetermined value or less, a judgment of switching an output to the received video signal is made.

It is preferable that the video signal recording/reproducing apparatus includes: a time information generation section for generating time information to be superimposed on the received video signal; a cuttable portion detection section for detecting a cuttable portion in the received video signal and recording, based on time information generated by the time information generation section, time information for each of a start and an end of a detected cuttable portion; a time information extraction section for extracting time information superimposed on the recorded received video signal; and a cuttable portion identification section for identifying, based on time information recorded by the cuttable portion detection section and time information extracted by the time information extraction section, whether or not the reproduced video signal belongs to the cuttable portion detected by the cuttable portion detection section. Then, if the cuttable portion detected by the cuttable portion detection section matches the cuttable portion identified by the cuttable portion identification section, the switch judgment section makes a judgment of switching an output.

Moreover, it is preferable that the semiconductor integrated circuit includes: a cuttable portion detection section for detecting a cuttable portion in the received video signal and recording, based on time information generated by the time information generation section, time information for each of a start and an end of the detected cuttable portion; a time information extraction section for extracting time information superimposed on data read out from the storage device; a cuttable portion identification section for identifying, based on time information recorded by the cuttable portion detection section and time information extracted by the time information extraction section, whether or not the reproduced video signal belongs to the cuttable portion detected by the cuttable portion detection section. Then, if the cuttable portion detected by the cuttable portion detection section matches the cuttable portion identified by the cuttable portion identification section, the switch judgment section makes a judgment of switching an output.

Moreover, it is preferable that the video signal recording/reproducing method includes: the time information generation step of generating time information to be superimposed on the received video signal; the cuttable portion detection step of detecting a cuttable portion in the received video signal and recording, based on time information generated by the time information generation step, time information for each of a start and an end of the detected cuttable portion; the time information extraction step of extracting time information superimposed on data read out from the storage device; the cuttable portion identification step of identifying, based on time information recorded by the cuttable portion detection step and time information extracted by the time information extraction step, whether or not the reproduced video signal belongs to the cuttable portion detected by the cuttable portion detection step. Then, if the cuttable portion detected by the cuttable portion detection step matches the cuttable portion identified by the cuttable portion identification step, the switch judgment section makes a judgment of switching an output.

According to the above-described apparatus, semiconductor integrated circuit and method, when a reproduced video signal being output comes to a cuttable portion and also a received video signal is contained in the cuttable portion, a judgment of switching an output to the received video signal is made.

It is preferable that the video signal recording/reproducing apparatus includes: a time information generation section for generating time information to be superimposed on the received video signal; a cuttable portion detection section for detecting a cuttable portion in the received video signal and recording, based on time information generated by the time information generation section, time information for each of a start and an end of the detected cuttable portion; a time information extraction section for extracting time information superimposed on the recorded received video signal; and a cuttable portion identification section for identifying, based on time information recorded by the cuttable portion detection section and time information extracted by the time information extraction section, whether or not the reproduced video signal belongs to the cuttable portion detected by the cuttable portion detection section. Then, when the switch judgment section receives from the cuttable portion identification section an identification result indicating that the reproduced video signal belongs to the cuttable portion detected by the cuttable portion detection section, the switch judgment section calculates a time difference between a time generated from the time information generation section and a time obtained from the time information extraction section, performs size comparison between the time difference and a predetermined value and, if the time difference is the predetermined value or less, makes a judgment of switching an output.

Moreover, it is preferable that the semiconductor integrated circuit includes: a time information generation section for generating time information to be superimposed on the received video signal; a cuttable portion detection section for detecting a cuttable portion in the received video signal and recording, based on time information generated by the time information generation section, time information for each of a start and an end of the detected cuttable portion; a time information extraction section for extracting time information superimposed on data read out from the storage device; a cuttable portion identification section for identifying, based on time information recorded by the cuttable portion detection section and time information extracted by the time information extraction section, whether or not the reproduced video signal belongs to the cuttable portion detected by the cuttable portion detection section. Then, when the switch judgment section receives from the cuttable portion identification section an identification result indicating that the reproduced video signal belongs to the cuttable portion detected by the cuttable portion detection section, the switch judgment section calculates a time difference between a time generated from the time information generation section and a time obtained from the time information extraction section, performs size comparison between the time difference and a predetermined value and, if the time difference is the predetermined value or less, makes a judgment of switching an output.

Moreover, it is preferable that the video signal recording/reproducing method includes: the time information generation step of generating time information to be superimposed on the received video signal; the cuttable portion detection step of detecting a cuttable portion in the received video signal and recording, based on time information generated by the time information generation section, time information for each of a start and an end of the detected cuttable portion; the time information extraction step of extracting time information superimposed on data read out from the storage device; the cuttable portion identification step of identifying, based on time information recorded by the cuttable portion detection step and time information extracted by the time information extraction step, whether or not the reproduced video signal belongs to the cuttable portion detected by the cuttable portion detection step. Then, in the switch judgment step, when it is determined by the cuttable portion identification step that the reproduced video signal belongs to the cuttable portion detected by the cuttable portion detection step, a time difference between a time generated by the time information generation step and a time extracted by the time information extraction step is calculated, size comparison between the time difference and a predetermined value is performed, and if the time difference is the predetermined value or less, a judgment of performing output switching is made.

According to the above-described apparatus, semiconductor integrated circuit and method, when a reproduced video signal being output comes to a cuttable portion and also a time difference between the reproduced video signal and a received video signal becomes a predetermined value or less, a judgment of switching an output to the received video signal is made.

Specifically, the cuttable portion is a commercial video image. Moreover, the cuttable portion is, specifically, a portion in which each of an image and a sound is in a certain state for a predetermined time or more.

It is preferable that each of the video signal recording/reproducing apparatus and the semiconductor integrated circuit includes: an output switching section for switching an output from the reproduced video signal to the received video signal, based on a judgment of the switch judgment section.

Moreover, it is preferable that the video signal recording/reproducing method includes: the output switching step of switching an output from the reproduced video signal to the received video signal, based on a judgment of the switch judgment step.

According to the above-described apparatus, semiconductor integrated circuit and method, based on a judgment of output switch made by the switch judgment section or the switch judgment step, an output is automatically switched from a reproduced video signal to a received video signal.

As has been described, according to the present invention, the following effect can be achieved. Assume that while a received video signal is compression-coded and is recorded as compressed stream data in a storage device, a reproduced video signal obtained by reproducing the recorded and compressed stream data is output. In this case, when the reproduced video signal comes to very close to the received video signal due to high speed reproduction, an output can be automatically or semi-automatically switched from the reproduced video signal to the received video signal. Particularly, in an analog broadcasting, a reproduced video signal is deteriorated to a further extent than a received video signal in terms of quality, and therefore, if an output is switched to the received video signal at an earlier time point, a viewer can comfortably enjoy a program.

### BRIEF DESCRIPTION OF THE DRAWINGS

FIG. 1 is a block diagram illustrating the configuration of a video signal recording/reproducing apparatus according to a first embodiment of the present invention.

FIG. 2 is a block diagram illustrating the configuration of a video signal recording/reproducing apparatus according to a second embodiment of the present invention.

FIG. 3 is a bock diagram illustrating the configuration of a video signal recording/reproducing apparatus according to a third embodiment of the present invention.

FIG. 4 is a block diagram illustrating the configuration of a known video signal recording/reproducing apparatus.

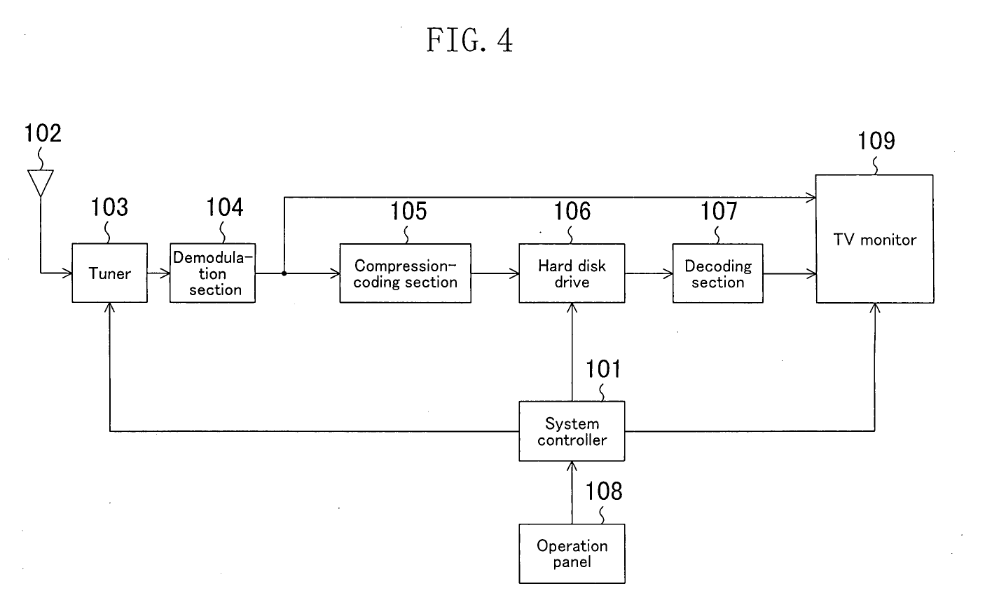

### DESCRIPTION OF THE PREFERRED EMBODIMENTS

Hereafter, the best mode for carrying out the present invention will be described with reference to the accompanying drawings.

### First Embodiment

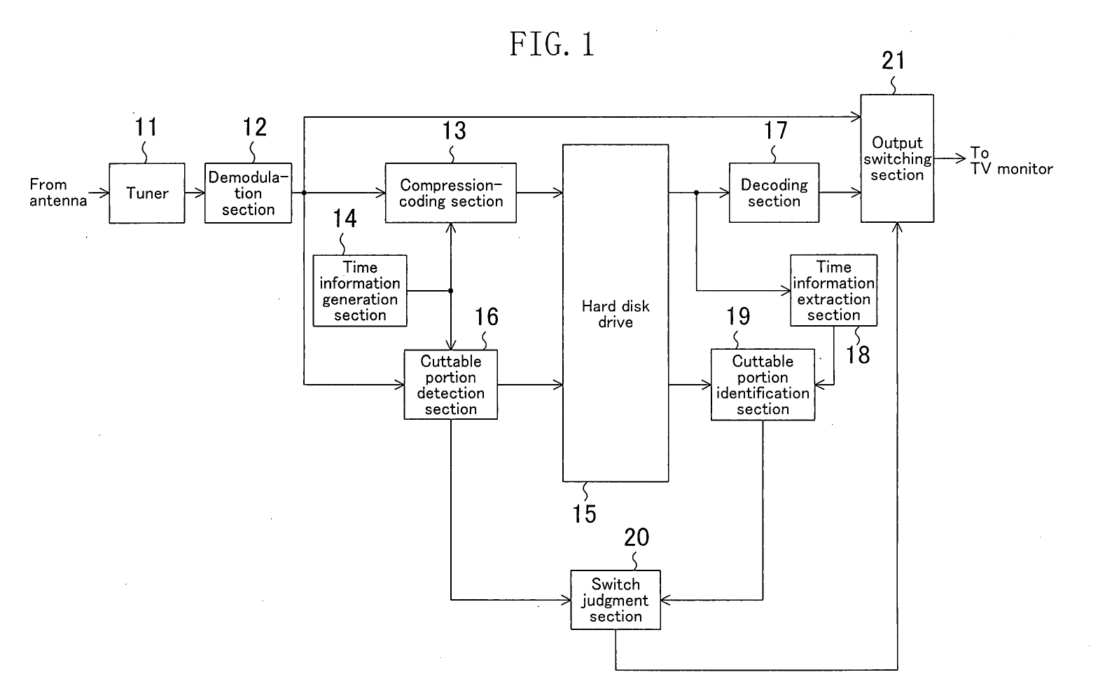

FIG. 1 is a block diagram illustrating the configuration of a video signal recoding/reproducing apparatus according to a first embodiment of the present invention. The video signal recording/reproducing apparatus of this embodiment includes a tuner 11, a demodulation section 12, a compression-coding section 13, a time information generation section 14, a hard disk drive 15 as a storage apparatus, a cuttable portion detection section 16, a decoding section 17, a time information extraction section 18, a cuttable portion identification section 19, a switch judgment section 20 and an output switching section 21.

The tuner 11 selects an arbitrary channel from a TV signal received from an antenna. The demodulation section 12 demodulates the TV signal of the channel selected by the tuner 11 and outputs a received video signal including a digital image signal and a digital sound signal. The compression-coding section 13 performs image/sound compression-coding such as MPEG (motion picture experts group) encoding to the received video signal output by the demodulation section 12 to multiplex time information from a start of processing, such as SCR (system clock reference) and PTS (presentation time stamp) which are defined by the MPEG encoding standard, and compressed data for each of an image and a sound. Thus, compressed stream data at a data rate of M bps is generated Then, the compression-coding section 13 records, on the hard drive disk 15, the compressed stream data.

The time information generation section 14 generates time information to be superimposed on the received video signal which has been modulated, and can be formed of a timer for measuring a time at a predetermined frequency. Time correction for the timer may be automatically performed based on a time signal for a predetermined time transmitted on a TV signal or may be manually performed by a user. Note that the operation of the time information generation section 14 corresponds to the step of generating time information.

The cuttable portion detection section 16 receives the received video signal which the demodulation section 12 has demodulated, and detects a cuttable portion in the received video signal. The cuttable portion detection section 16 receives current time information from the time information generation section 14 and, when the cuttable portion detection section 16 detects a cuttable portion, time information for each of a start and an end of the cuttable portion is recorded on the hard drive disk 15. Specifically, using, as a unit, compressed stream in a predetermined period, such as GOP (group of pictures) unit defined by the MPEG encoding standard, the time information is recorded on the hard disk drive 15. Note that the operation of the cuttable portion detection section 16 corresponds to the step of detecting a cuttable portion.

As a cuttable portion to be detected by the cuttable portion detection section 16, for example, a commercial video image portion and a portion in which an image and a sound stay in a certain state for a predetermined time or more are considered. A viewer does not desire to view a commercial video image and therefore cutting such a commercial video image does not cause any particular problem. A commercial video image can be detected due to switching of the received video signal from a bilingual broadcast to a monolingual broadcast. Moreover, a commercial video image can be detected based on interval information during a silent period in the received video signal. Furthermore, when commercial information is superimposed on a TV signal which has not been demodulated by the demodulator 12 yet, a commercial video image can be detected from the TV signal which has not been demodulated. Moreover, even if a program does not include a commercial video image, a portion in which an image and a sound stay in a certain state for a predetermined time can be detected as a cuttable portion. For example, a portion including a still image and no sound does not provide any new information to a viewer and, thus, cutting the still image does not cause any particular problem. Detection of the portion can be peformed by detecting that a period in which fluctuations in a sound signal level are sufficiently small continues for a predetermined period and the amount of fluctuations in the sum of difference values for signal levels for each pixel in each frame period of an image signal is sufficiently small during the predetermined period.

In an above-described manner, time information for each of the received video signal and a cuttable portion is recorded on the hard disk drive 15.

On the other hand, the decoding section 17 reads out compressed stream data from the hard disk drive 15, performs decoding such as MPEG decoding to the compressed stream data which has been read out and outputs a reproduced video signal including a digital image signal and a digital sound signal. Read-out of compressed stream data from the hard disk drive 15 can be simultaneously performed with write-in of compressed stream data by the compression-coding section 13. That is, it is possible to read out and reproduce video image contents recorded at a time point in the past while receiving and recording video image contents.

The decoding section 17 continuously or discontinuously reads out compressed stream data at a rate twice faster than that for recording, i.e., at a rate of 2×M bps. When the decoding section 17 continuously reads out compressed stream data at a rate twice faster than that in recording, the reproduced video signal is output with the same intervals as those for the received video signal and at a rate twice faster than that in normal reproduction. Specifically, in a predetermined period, one of every two frames of the reproduced video signal reproduced in normal reproduction is thinned out, so that the reproduced video signal is output at double speed. On the other hand, when compressed stream data is discontinuously read out, the decoding section 17 connects compressed stream data, which have been read out with intervals therebetween, and continuously outputs the reproduced video signal. That is, compared to normal reproduction, the video signal is output with part thereof skipped. As a result, the reproduced video signal is reproduced at a high rate.

The time information extraction section 18 receives the stream data read out from the hard disk drive 15 and extracts time information superimposed on the compressed stream data. As has been described, the time information is generated by a time information generation section 14 and superimposed on the compressed stream data by the compression-coding section 13. Note that the operation of the time information extraction section 18 corresponds to the step of detecting time information.

The cuttable portion identification section 19 receives the time information extracted by the time information extraction section 18 and identifies, with reference to the time information which the cuttable portion detection section 16 has recorded on the hard disk drive 15, whether or not the reproduced video signal belongs to the cuttable portion detected by the cuttable portion detection section 16. Specifically, if a time extracted with respect to the reproduced video signal is between start and end times of the cuttable portion, the cuttable portion detection section 19 identifies that the reproduced video signal belongs to the cuttable portion. Note that the operation of the cuttable portion identification section 19 corresponds to the step of identifying a cuttable portion.

The switch judgment section 20 receives information for a cuttable portion detected by the cuttable portion detection section 16 and information for a cuttable portion identified by the cuttable portion identification section 19, performs logic judgment based on these information, generates a video image switching signal for controlling the output switching section 21 and then output the video image switching signal. Specifically, the switch judgment section 20 examines whether or not a cuttable portion detected by the cuttable portion detection section 16 is identical to a cuttable portion identified by the cuttable portion identification section 19. If it is judged that they are identical to each other, the switch judgment section 20 outputs a video image switching signal so as to switch a video signal to be output from the reproduced video signal to the received video signal. Note that the operation of the switch judgment section 20 corresponds to the step of making a judgment of switching an output.

As an example for video signal switching by the switch judgment section 20, the case where when the reproduced video signal is fast-forwarding reproduced and the fast-forwarding comes to a commercial video image portion while the commercial video image is being received, a video image displayed on a TV monitor is automatically switched from the reproduced video image to the received video image. In this case, part of the commercial video image is cut out. However, as described above, the commercial video image is not what a viewer desires to see and, therefore, no particular problem is caused.

The received video signal demodulated by the demodulation section 12 and the reproduced video signal decoded by the decoding section 17 are input to the output switch section 21, and the output switch section 21 selects one of the input video images according to the video image switching signal output by the switch judgment section 20 and then outputs the selected signal to the TV monitor. Note that the operation of the output switching section 21 corresponds to the step of making a judgment of switching an output.

As has been described, according to this embodiment, the reproduced video signal is reproduced at high speed by fast-forwarding reproduction or skip reproduction. Then, when a cuttable portion of the reproduced video signal has caught up with a cuttable portion of the received video signal, a video signal to be output can be automatically switched from the reproduced video signal to the received video signal.

Note that the compression-coding section 13, the time information generation section 14, the cuttable portion detection section 16, the decoding section 17, the time information extraction section 18, the cuttable portion identification section 19, the switch judgment section 20 and the output switching section 21 can be achieved as a semiconductor integrated circuit.

### Second Embodiment

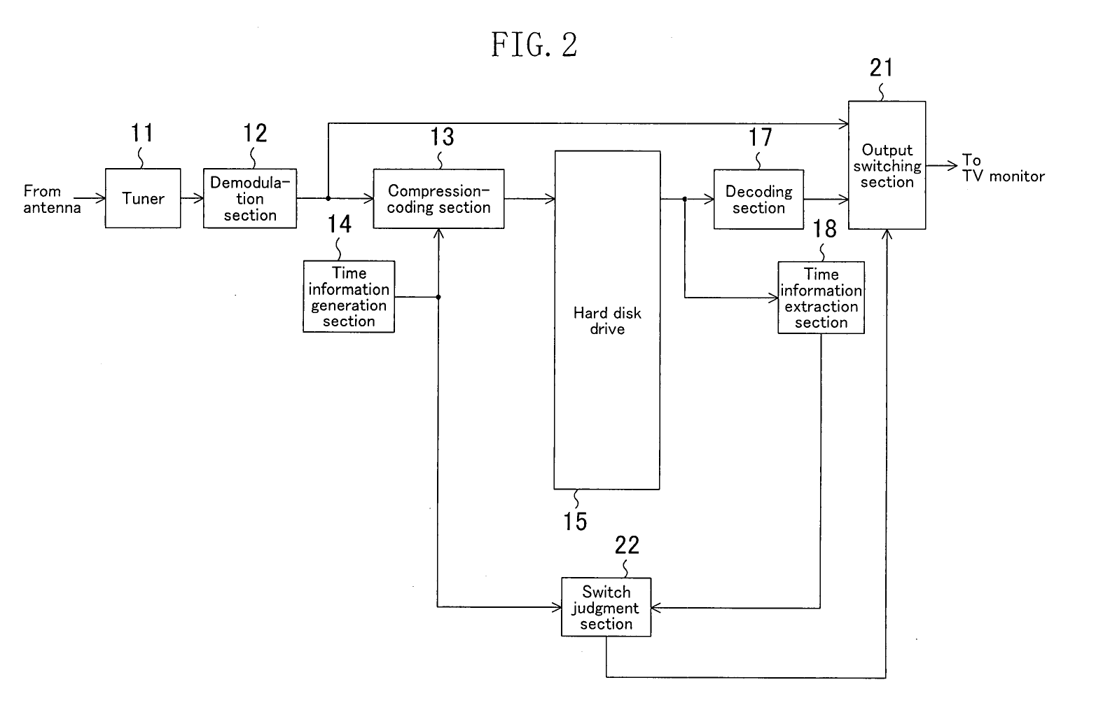

FIG. 2 is a block diagram illustrating the configuration of a video signal recording/reproducing apparatus according to a second embodiment of the present invention. The video signal recording/reproducing apparatus of this embodiment has a configuration obtained by omitting the cuttable portion detection section 16 and the cuttable portion identification section 19 from the video signal recording/reproducing apparatus of the first embodiment and including a switch judgment section 22. Hereinafter, the switch judgment section 22 will be described in detail.

The switch judgment section 22 receives time information to be superimposed on a received video signal from the time information generation section 14 as well as time information extracted for the reproduced video signal from the time information extraction section 18, performs logic judgment based on these time informations, generates a video image switching signal for controlling the output switching section 21 and then outputs the video image switching signal. Specifically, the switch judgment section 22 calculates, as a time difference between the received video signal and the reproduced video signal, a time difference between a time obtained from the time information generation section 14 and a time obtained from the time information extraction section 18. Then, if the time difference is larger than a predetermined value, the reproduced video signal is continuously output, and if the time difference is the predetermined value or less, a video image switching signal is output so as to switch from the reproduced video signal to the received video signal.

As an example for video signal switching by the switch judgment section 22, the case where when after 10 minutes have lapsed since a start of recording of the received video signal, reproduction of the recorded video signal is started will be considered. A while after the reproduction has been started, a time of the received video signal and a time of the reproduced video signal are far different from each other. Therefore, a viewer has the reproduced video signal displayed on a TV monitor and enjoys it. During reproduction, a video image such as a commercial video image which is unnecessary to the viewer is assumed to be reproduced at high speed or in some other manner by an operation by the viewer or automatically. Then, as such high-speed reproduction or the like is repeated for a plurality of times, the time difference between the reproduced video signal and the received video signal is gradually reduced. When the time difference becomes a predetermined value or less, the reproduced video signal is automatically switched to the received video signal.

As has been described, according to this embodiment, the reproduced video signal is reproduced by fast-forwarding reproduction or skip reproduction. Then, when the fast forwarding comes to very close to the reproduced video signal, a video signal to be output can be automatically switched from the reproduced video signal to the received video signal. In the first embodiment, unless each of the received video signal and the reproduced image signal belongs to one cuttable portion, a video signal can not be automatically switched. In contrast, according to this embodiment, whether or not each of the received video signal and the reproduced image signal belongs to one cuttable portion, a video signal is switched at a time when the reproduced video signal has caught up with the received image signal. Accordingly, an output signal can be switched to the received video signal at a sooner time than in the first embodiment. Moreover, the cuttable portion detection section and the cuttable portion identification section do not have to be provided. Therefore, the configuration of this embodiment is more simple than that of the first embodiment.

Note that the compression-coding section 13, the time information generation section 14, the decoding section 17, the time information extraction section 18, the switch judgment section 20 and the output switching section 21 can be achieved as a semiconductor integrated circuit.

### Third Embodiment

According to the first embodiment, when the reproduced video signal and a received video signal belong to the same cuttable portion, an output is switched from the reproduced video signal to the received video signal. Therefore, a main body of a program is not cut out. However, if the received video signal falls off from a commercial video image even very slightly, the output is not switched until a next commercial video image.

On the other hand, according to the second embodiment, as soon as the reproduced video signal comes to very close to the received video signal, the output is switched. However, there might be cases where an output is switched in some other portion than a cuttable portion, i.e., in the middle of a main body of a program. This is against viewers' needs of wanting to enjoy a main body of a program and therefore is not preferable.

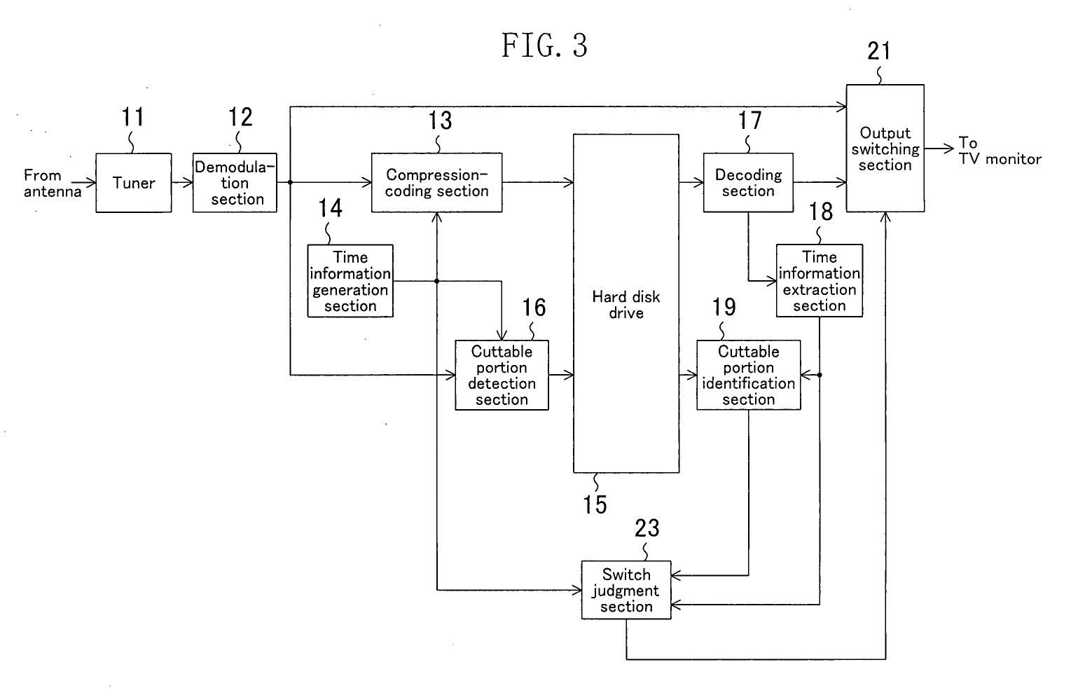

Then, as a third embodiment of the present invention, a video signal recording/reproducing apparatus for performing output switching at an earlier point of time while avoiding cutting of a main body of a program as much as possible will be considered. FIG. 3 is a block diagram illustrating the configuration of a video signal recording/reproducing apparatus according to this embodiment. The video signal recording/reproducing apparatus of this embodiment has a configuration obtained by adding the cuttable portion detection section 16 and the cuttable portion identification section 19 of the video signal recording/reproducing apparatus of the first embodiment to the video signal recording/reproducing apparatus of the second embodiment. Hereinafter, a switch judgment section 23 in the video signal recording/reproducing apparatus of this embodiment will be described in detail.

The switch judgment section 23 receives a result of identification by the cuttable portion identification section 19 and is noticed whether or not the reproduced video signal belongs to a cuttable portion. Normally, as in the second embodiment, the switch judgment section 23 monitors whether or not a time difference between the reproduced video signal and the received video signal is a predetermined value or less. Even with the time difference of the predetermined value or less, unless the reproduced video signal belongs to the cuttable portion, automatic switching of the video signal is not performed. Thus, the video signal is not automatically switched in the middle of the program.

Moreover, when the switch judgment section 23 receives from the cuttable portion identification section 19 information that the reproduced video signal comes to a cuttable portion, the switch judgment section 23 sets the predetermined value to be larger than a length of time of the cuttable portion. For example, assume that the predetermined value is determined to be 10 seconds. When the reproduced video signal comes to a 90-second commercial video image, the switch judgment section 23 resets the predetermined value to be 93 seconds and performs switch judgment. In this case, if the received video signal exceeds the end of the commercial video image, e.g., by 3 seconds or less, a time difference between the received video signal and the reproduced video signal is 93 seconds at most and is considered to be within the range of the reset predetermined value or less. Therefore, in this case, the video signal is switched.

In the case of the above-described example, a video signal can not switched until a next commercial video image in the video signal recording/reproducing apparatus of the first embodiment. In contrast, according to this embodiment, a video signal can be switched to the received video signal without waiting for the next commercial video image. In this case, contents of the main body within 3 seconds after a commercial video image is finished are cut out. However, compared to the case where contents in the middle of a main body of a program are cut out, the amount of information which a viewer loses is considered to be less.

As has been described, according to this embodiment, a video image signal can be switched at an earlier point of time than in the first embodiment and with a smaller cut of contents of a main body of a program than that in the second embodiment.

Note that in the video signal recording/reproducing apparatus of each of the above-described embodiments, the output switching section 21 automatically performs switching from the reproduced video signal to the received video signal. However, the video signal recording/reproducing apparatus may be formed so that switching is semiautomatically performed, i.e., a viewer himself/herself who receives an instruction from the video signal recording/reproducing apparatus switches from the reproduced video signal to the received video signal. In the case where a viewer performs switching by him/herself, a signal indicating that switching of a video signal is possible can be output from, for example, the switch judgment section 20, 22 and 23 to the viewer.

Moreover, as a condition for output switching other than ones described above, output switching may be performed under the condition where the bit rate of the reproduced video signal is lower than a predetermined level and the time difference between the reproduced video signal and the received image signal is smaller than a predetermined value may be used. A reason for this is as follows. If the bit rate of the reproduced video signal is low, the reproduced image is considered to be a still image or an image quality is deteriorated. In such a case, it is more preferable to switch to the received video signal.

Moreover, output switching may be performed under the condition where a generation bit amount according to compression-coding of the received video signal is smaller than a predetermined value and the time difference between the reproduced video signal and the received video signal is smaller than a predetermined value. If each of respective bit rates in the coding side and the decoding side is relatively small, the amount of data stored in a bit buffer is assumed to be relatively small. Accordingly, in that case, even when output switching is performed, the amount of data to be lost can be considered to be relatively small.

Moreover, for example, if it is possible to detect whether or not a viewer is facing a TV monitor, output switching may be made to be performed when the time difference between the reproduced video signal and the received video signal is smaller than the predetermined value and also the viewer looks away from the TV monitor. In that case, even if part of the main body of the program is cut out by the output switching, the viewer does not look at the video image and, therefore, there is no particular problem.

Moreover, the video signal recording/reproducing apparatus of each of the above-described embodiment is applicable to each of an analog broadcasting and a digital broadcasting.

The video signal recording/reproducing apparatus according to the present invention allows automatic switching from a reproduced video signal to a received video signal. Therefore, the video signal recording/reproducing apparatus of the present invention is useful as a DVD recorder, a HDD recorder or the like. Moreover, the video signal recording/reproducing apparatus of the present invention is also useful as a TV image capture board for computers.

1. A video signal recording/reproducing apparatus which selectively outputs, while recording a received video signal, one of the received video signal and a reproduced video signal obtained by reproducing a recorded received video signal, the apparatus comprising:
a switch judgment section for examining whether or not each of the received video signal and the reproduced video signal satisfies a predetermined condition while the reproduced video signal is output, and making a judgment of switching of an output to the received video signal if the predetermined condition is satisfied.

2. The video signal recording/reproducing apparatus of claim 1, further comprising:
a time information generation section for generating time information to be superimposed on the received video signal; and
a time information extraction section for extracting time information superimposed on the recorded received video signal,
wherein the switch judgment section calculates a time difference between a time generated from the time information generation section and a time obtained from the time information extraction section, performs size comparison between the time difference and a predetermined value and, if the time difference is the predetermined value or less, makes a judgment of switching an output.

3. The video signal recording/reproducing apparatus of claim 1, further comprising:
a time information generation section for generating time information to be superimposed on the received video signal;
a cuttable portion detection section for detecting a cuttable portion in the received video signal and recording, based on time information generated by the time information generation section, time information for each of a start and an end of the detected cuttable portion;
a time information extraction section for extracting time information superimposed on the recorded received video signal; and
a cuttable portion identification section for identifying, based on time information recorded by the cuttable portion detection section and time information extracted by the time information extraction section, whether or not the reproduced video signal belongs to the cuttable portion detected by the cuttable portion detection section,
wherein if the cuttable portion detected by the cuttable portion detection section matches the cuttable portion identified by the cuttable portion identification section, the switch judgment section makes a judgment of switching an output.

4. The video signal recording/reproducing apparatus of claim 3, wherein the cuttable portion is a commercial video image.

5. The video signal recording/reproducing apparatus of claim 3, wherein the cuttable portion is a portion in which each of an image and a sound is in a certain state for a predetermined time or more.

6. The video signal recording/reproducing apparatus of claim 1, further comprising:
a time information generation section for generating time information to be superimposed on the received video signal;
a cuttable portion detection section for detecting a cuttable portion in the received video signal and recording, based on time information generated by the time information generation section, time information for each of a start and an end of the detected cuttable portion;
a time information extraction section for extracting time information superimposed on the recorded received video signal; and
a cuttable portion identification section for identifying, based on time information recorded by the cuttable portion detection section and time information extracted by the time information extraction section, whether or not the reproduced video signal belongs to the cuttable portion detected by the cuttable portion detection section,
wherein when the switch judgment section receives from the cuttable portion identification section an identification result indicating that the reproduced video signal belongs to the cuttable portion detected by the cuttable portion detection section, the switch judgment section calculates a time difference between a time generated from the time information generation section and a time obtained from the time information extraction section, performs size comparison between the time difference and a predetermined value and, if the time difference is the predetermined value or less, makes a judgment of switching an output.

7. The video signal recording/reproducing apparatus of claim 6, wherein the cuttable portion is a commercial video image.

8. The video signal recording/reproducing apparatus of claim 6, wherein the cuttable portion is a portion in which each of an image and a sound is in a certain state for a predetermined time or more.

9. The video signal recording/reproducing apparatus of claim 1, further comprising:
an output switching section for switching an output from the reproduced video signal to the received video signal, based on a judgment of the switch judgment section.

10. A semiconductor integrated circuit to which a received video signal is input and which selectively outputs, while recording the received video signal in a storage device, one of the received video signal and a reproduced video signal obtained by decoding data read out from the storage device, the circuit comprising:
a switch judgment section for examining whether or not each of the received video signal and the reproduced video signal satisfies a predetermined condition while the reproduced video signal is output and making a judgment of switching an output to the received video signal if the predetermined condition is satisfied.

11. The semiconductor integrated circuit of claim 10, further comprising:
a time information generation section for generating time information to be superimposed on the received video signal; and
a time information extraction section for extracting time information superimposed on data read out from the storage device,
wherein the switch judgment section calculates a time difference between a time generated from the time information generation section and a time obtained from the time information extraction section, performs size comparison between the time difference and a predetermined value and, if the time difference is the predetermined value or less, makes a judgment of switching an output.

12. The semiconductor integrated circuit of claim 10, further comprising:
a time information generation section for generating time information to be superimposed on the received video signal;
a cuttable portion detection section for detecting a cuttable portion in the received video signal and recording, based on time information generated by the time information generation section, time information for each of a start and an end of the detected cuttable portion;
a time information extraction section for extracting time information superimposed on data read out from the storage device;
a cuttable portion identification section for identifying, based on time information recorded by the cuttable portion detection section and time information extracted by the time information extraction section, whether or not the reproduced video signal belongs to the cuttable portion detected by the cuttable portion detection section,
wherein if the cuttable portion detected by the cuttable portion detection section matches the cuttable portion identified by the cuttable portion identification section, the switch judgment section makes a judgment of switching an output.

13. The semiconductor integrated circuit of claim 12, wherein the cuttable portion is a commercial video image.

14. The semiconductor integrated circuit of claim 12, wherein the cuttable portion is a portion in which each of an image and a sound is in a certain state for a predetermined time or more.

15. The semiconductor integrated circuit of claim 10, further comprising:
a time information generation section for generating time information to be superimposed on the received video signal;
a cuttable portion detection section for detecting a cuttable portion in the received video signal and recording, based on time information generated by the time information generation section, time information for each of a start and an end of the detected cuttable portion;
a time information extraction section for extracting time information superimposed on data read out from the storage device;
a cuttable portion identification section for identifying, based on time information recorded by the cuttable portion detection section and time information extracted by the time information extraction section, whether or not the reproduced video signal belongs to the cuttable portion detected by the cuttable portion detection section,
wherein when the switch judgment section receives from the cuttable portion identification section an identification result indicating that the reproduced video signal belongs to the cuttable portion detected by the cuttable portion detection section, the switch judgment section calculates a time difference between a time generated from the time information generation section and a time obtained from the time information extraction section, performs size comparison between the time difference and a predetermined value and, if the time difference is the predetermined value or less, makes a judgment of switching an output.

16. The semiconductor integrated circuit of claim 15, wherein the cuttable portion is a commercial video image.

17. The semiconductor integrated circuit of claim 15, wherein the cuttable portion is a portion in which each of an image and a sound is in a certain state for a predetermined time or more.

18. The semiconductor integrated circuit of claim 10, further comprising:
an output switching section for switching an output from the reproduced video signal to the received video signal based on a judgment of the switch judgment section.

19. A method for recording/reproducing a video signal in which a received video signal is input and, while the received video signal is recorded in a storage device, one of the received video signal and a reproduced video signal obtained by decoding data read out from the storage device is selectively output, the method comprising:
the switch judgment step of examining whether or not each of the received video signal and the reproduced video signal satisfies a predetermined condition while the reproduced video signal is output and making a judgment of switching an output to the received video signal if the predetermined condition is satisfied.

20. The video signal recording/reproducing method of claim 19, further comprising:
the time information generation step of generating time information to be superimposed on the received video signal: and
the time information extraction step of extracting time information superimposed on data read out from the storage device,
wherein in the switch judgment step, a time difference between a time generated by the time information generation step and a time extracted by the time information extraction section is calculated, size comparison between the time difference and a predetermined value is performed and, if the time difference is the predetermined level or less, a judgment of switching an output is made.

21. The video signal recording/reproducing method of claim 19, further comprising:
the time information generation step of generating time information to be superimposed on the received video signal;
the cuttable portion detection step of detecting a cuttable portion in the received video signal and recording, based on time information generated by the time information generation step, time information for each of a start and an end of the detected cuttable portion;
the time information extraction step of extracting time information superimposed on data read out from the storage device;
the cuttable portion identification step of identifying, based on time information recorded by the cuttable portion detection step and time information extracted by the time information extraction step, whether or not the reproduced video signal belongs to the cuttable portion detected by the cuttable portion detection step,
wherein if the cuttable portion detected by the cuttable portion detection step matches the cuttable portion identified by the cuttable portion identification step, the switch judgment section makes a judgment of switching an output.

22. The video signal recording/reproducing method of claim 21, wherein the cuttable portion is a commercial video.

23. The video signal recording/reproducing method of claim 21, wherein the cuttable portion is a portion in which each of an image and a sound is in a certain state for a predetermined time or more.

24. The video signal recording/reproducing method of claim 19, further comprising:
the time information generation step of generating time information to be superimposed on the received video signal;
the cuttable portion detection step of detecting a cuttable portion in the received video signal and recording, based on time information generated by the time information generation section, time information for each a start and an end of the detected cuttable portion;
the time information extraction step of extracting time information superimposed on data read out from the storage device;
the cuttable portion identification step of identifying, based on time information recorded by the cuttable portion detection step and time information extracted by the time information extraction step, whether or not the reproduced video signal belongs to the cuttable portion detected by the cuttable portion detection step,
wherein in the switch judgment step, when it is determined by the cuttable portion identification step that the reproduced video signal belongs to the cuttable portion detected by the cuttable portion detection step, a time difference between a time generated by the time information generation step and a time extracted by the time information extraction step is calculated, size comparison between the time difference and a predetermined value is performed and, if the time difference is the predetermined value or less, a judgment of performing output switching is made.

25. The video signal recording/reproducing method of claim 24, wherein the cuttable portion is a commercial video.

26. The video signal recording/reproducing method of claim 24, wherein the cuttable portion is a portion in which each of an image and a sound is in a certain state for a predetermined time or more.

27. The video signal recording/reproducing method of claim 19, further comprising:
the output switching step of switching an output from the reproduced video signal to the received video signal, based on a judgment of the switch judgment step.
